(19) United States
(12) Patent Application Publication
(10) Pub. No.: US 2006/0197774 A1
(43) Pub. Date: Sep. 7, 2006

(54) Method of Adjusting Saturation of Luminance-based Video

(76) Inventors: Tsung-Ming Wang, Hsinchu (TW); Chao-Chee Ku, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 10/907,682

(22) Filed: Apr. 12, 2005

(30) Foreign Application Priority Data
Mar. 1, 2005 (TW) 094106097

(51) Int. Cl. G09G 5/02

(52) U.S. Cl. 345/589

(57) ABSTRACT

To strengthen a color of an image pixel without producing contour artifacts includes generating a relation between luminance and maximum chrominance vectors in each sub-color palette, generating a saturation factor of the image pixel according to a maximum chrominance vector corresponding to luminance of the image pixel, and adjusting a chrominance vector of the image pixel according to the saturation factor.

### BACKGROUND OF INVENTION

1. Field of the Invention

The present invention relates to a method of processing an image, more particularly, a method of adjusting chrominance vector of an image pixel.

2. Description of the Prior Art

By adjusting saturation an image can appear more vivid. The conventional method of adjusting saturation of an image is by increasing gain of chrominance vector of the image, which is equivalent to a method of chrominance vector of the image multiplying a saturation factor so that the image will appear to be more vivid.

However, the chrominance vector located in the color model is an intermediate width, and it is shaped like an olive, in other words, chrominance vector of an image changes accordingly to luminance of the image and it has different maximum chrominance vector value, therefore, before knowing the luminance of the image on the color model corresponding to the maximum chrominance vector, under the situation when the chrominance vector of the image multiples the saturation factor rashly, under the prior art method as mentioned above, if the degree of saturation factor is excessively small, the image will lose its original brightness; if the degree of saturation factor is oversized, then contour artifacts will appear on the image.

### SUMMARY OF INVENTION

The main objective of the claimed invention relates to a method of adjusting an image pixel to a maximum vector to solve the above-mentioned problem.

The claimed invention relates a method of adjusting saturation of luminance-based video, the method comprising: generating a relation between luminance and maximum chrominance vectors in each sub-color palette.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a flowchart of a method of adjusting saturation of an image.

FIG. 2 illustrates a diagram of a color palette at maximum chrominance vector of a luminance.

FIG. 3 to FIG. 10 illustrates a relationship between luminance and maximum chrominance vector of a video image.

### DETAILED DESCRIPTION

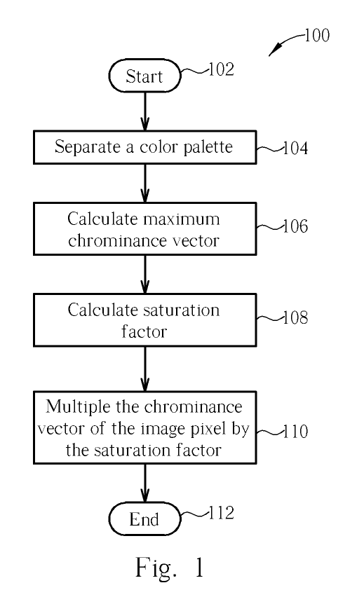

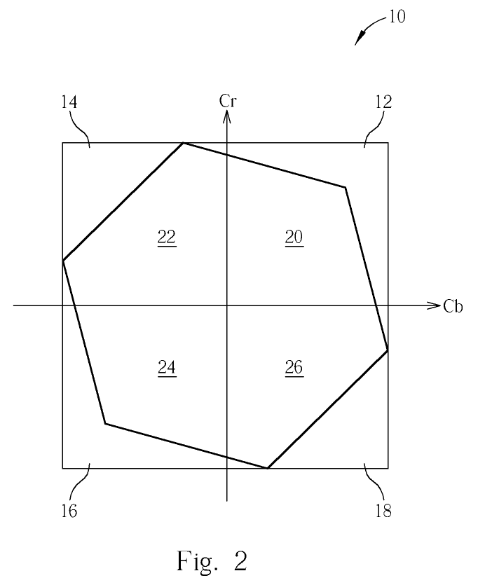

Please refer to FIG. 1 and FIG. 2. FIG. 1 illustrates a flowchart of a method of adjusting saturation of an image. FIG. 2 illustrates a diagram of a color palette 10 at maximum chrominance vector of a luminance. Horizontal axis is Cb and vertical axis is Cr. Hexagon of the color palette 10 corresponds to the maximum chrominance vector of the luminance. The method 100 comprises the following steps:

Step 102: start;

Step 104: separate a color palette 10 corresponding to a color model of a video image V into a plurality of sub-color palette 20, 22, 24, and 26;

(As shown in FIG. 2, the color palette 10 is separated into four sub-color palettes of four quadrants, which is a first sub-color palette 20 located in a first quadrant 12, a second sub-color palette 22 located in a second quadrant 14, a third sub-color palette 24 located in a third quadrant 16 and a fourth sub-color palette 26 located in a fourth quadrant 18.)

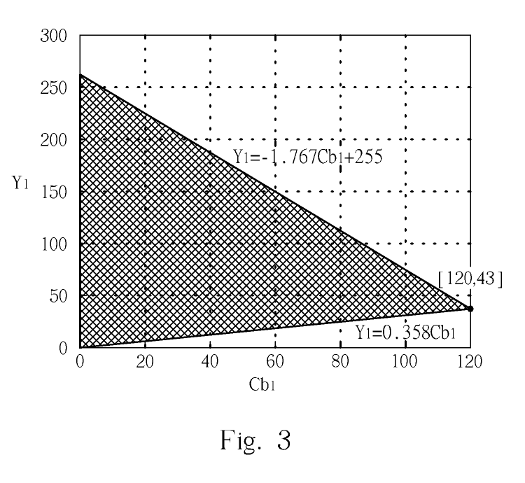

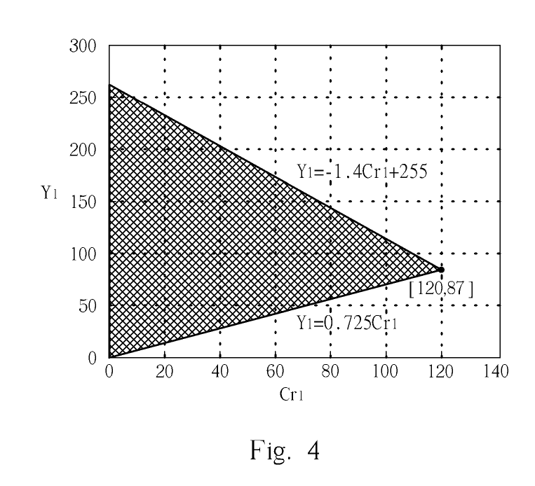

Step 106: generate a relation between luminance and maximum chrominance vectors in each sub-color palette according to each sub-color palette 20, 22, 24, and 26 located at the color palette 10;
(Please refer to FIG. 3 and FIG. 4 for more details. Take the first sub-color palette 20 located in the first quadrant 12 for example, when luminance Y1 of the first sub-color palette 20 is less than 43, as Y1=0.358Cb1, Y1=0.725Cr1, maximum chrominance vector (Cb1, Cr1) corresponding to luminance Y1 equals to

$$( \frac{{Y}_{1}}{0.358} , \frac{{Y}_{1}}{0.725} ) ;$$

as luminance Y1 is situated between 43 and 87, maximum chrominance vector (Cb1, Cr1) corresponding to luminance Y1 equals to

$$( \frac{{Y}_{1} - 255}{- 1.767} , \frac{{Y}_{1}}{0.725} ) ;$$

when luminance Y1 is greater than 87, maximum chrominance vector (Cb1, Cr1) corresponding to luminance Y1 equals to

$$( \frac{{Y}_{1} - 255}{- 1.767} , \frac{{Y}_{1} - 255}{- 1.4} ) .$$

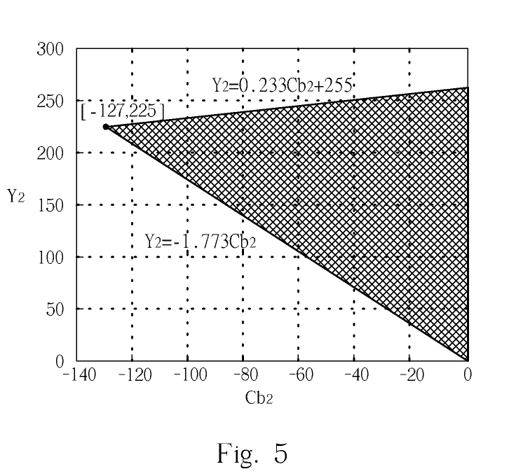

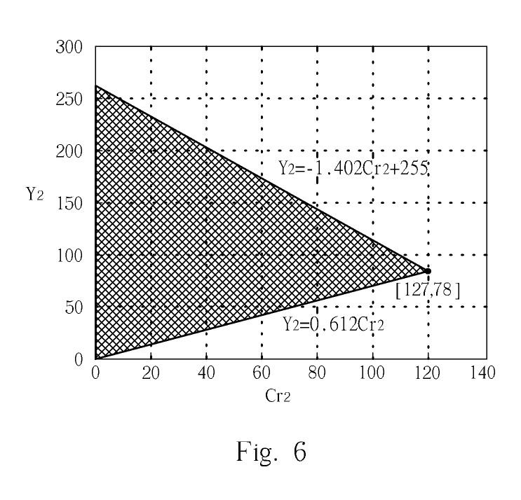

Please refer to FIG. 5 and FIG. 6. Take the second sub-color palette 22 located in the second quadrant 14 for example, when luminance Y2 of the second sub-color palette 22 is less than 78, maximum chrominance (Cb2, Cr2) corresponding to luminance Y2 equals to

$$( \frac{{Y}_{2}}{- 1.773} , \frac{{Y}_{2}}{0.612} ) ;$$

when luminance Y2 is situated between 78 and 225, maximum chrominance (Cb2, Cr2) corresponding to luminance Y2 equals to

$$( \frac{{Y}_{2}}{- 1.773} , \frac{{Y}_{2} - 255}{- 1.402} ) ;$$

when luminance Y2 is greater than 225, maximum chrominance vector (Cb2, Cr2) corresponding to luminance Y2 equals to

$$( \frac{{Y}_{2} - 255}{0.223} , \frac{{Y}_{2} - 255}{- 1.402} ) .$$

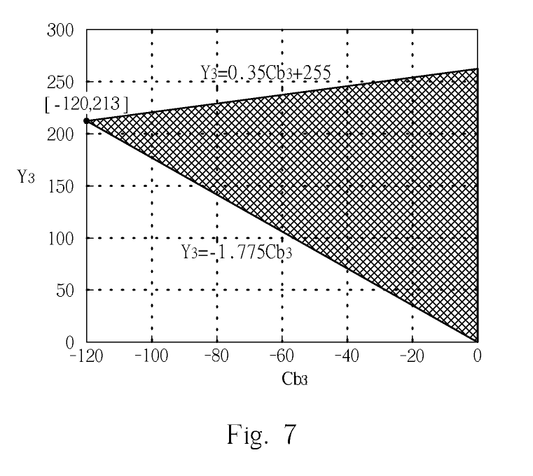

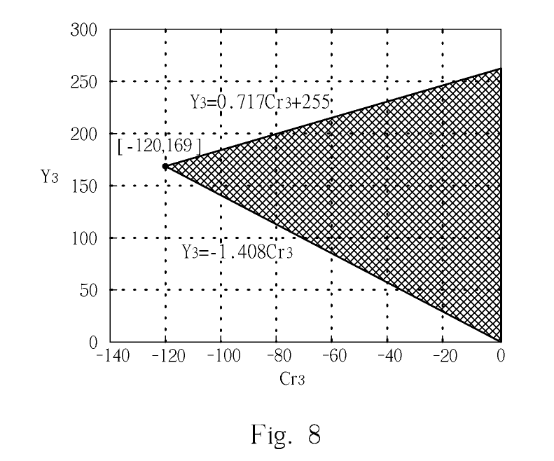

Please refer to FIG. 7 and FIG. 8. Take the third sub-color palette 24 located in the third quadrant 16, when luminance Y3 of the third color palette 24 is less than 169, maximum chrominance (Cb3, Cr3) corresponding to luminance Y3 equals to

$$( \frac{{Y}_{3}}{- 1.775} , \frac{{Y}_{3}}{1.408} ) ;$$

when luminance Y3 is situated between 169 and 213, maximum chrominance (Cb3, Cr3) corresponding to luminance Y3 equals to

$$( \frac{{Y}_{3}}{- 1.775} , \frac{{Y}_{3} - 255}{0.717} ) ;$$

when luminance Y3 is greater 213, maximum chrominance vector (Cb3, Cr3) corresponding to luminance Y3 equals to

$$( \frac{{Y}_{3} - 255}{0.35} , \frac{{Y}_{3} - 255}{0.717} ) .$$

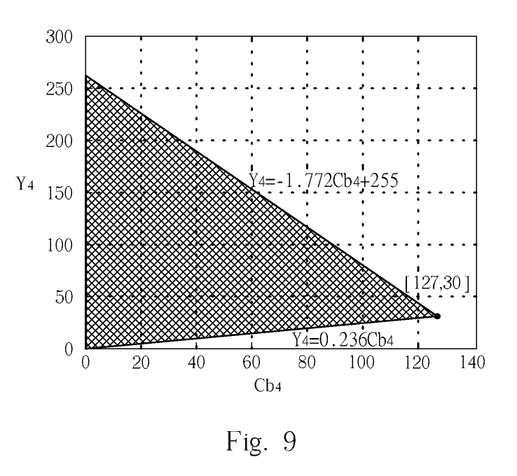

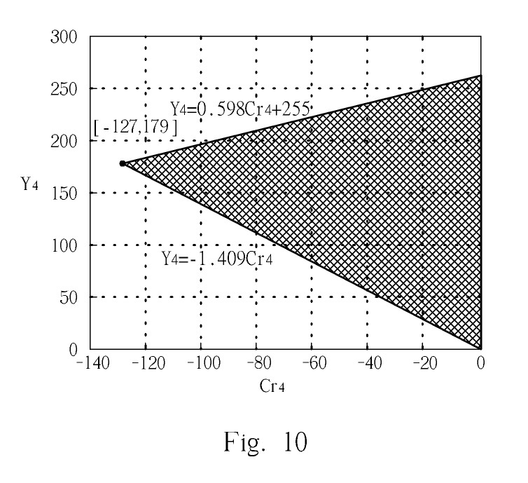

Please refer to FIG. 9 and FIG. 10, take the fourth sub-color palette 26 located in the fourth quadrant 18, when luminance Y4 of the fourth palette 26 is less than 30, maximum chrominance vector (Cb4, Cr4) corresponding to luminance Y4 equals to

$$( \frac{{Y}_{4}}{0.236} , \frac{{Y}_{4}}{- 1.409} ) ;$$

when luminance Y4 is situated between 30 and 179, maximum chrominance vector (Cb4, Cr4) corresponding to luminance Y4 equals to

$$( \frac{{Y}_{4} - 225}{- 1.772} , \frac{{Y}_{4}}{- 1.409} ) ;$$

when luminance Y4 is greater than 179, maximum chrominance vector (Cb4, Cr4) corresponding to luminance Y4 equals to

$$( \frac{{Y}_{4} - 225}{- 1.772} , \frac{{Y}_{4} - 255}{0.598} ) .$$

Step 108: generate saturation factor of the image pixel according to maximum chrominance vector corresponding to luminance of the image pixel; (For example, if luminance of an image pixel is 100, and chrominance vector (Cb, Cr) of the image pixel equals to (−30, 80), which means that chrominance vector (Cb, Cr) of the image pixel falls under the second sub-color palette 22, according to FIG. 5 and FIG. 6, as 100 is situated between 78 and 225, therefore maximum chrominance vector (Cbmax, Crmax) corresponding to luminance Y2 equals to

$$( \frac{{Y}_{2}}{- 1.773} , \frac{{Y}_{2} - 255}{1.402} ) = ( \frac{100}{- 1.773} , \frac{100 - 255}{- 1.402} ) = ( - 56.4 , 110.5 ) .$$

The saturation factor is not greater than a smaller value of −56.4/−30 and 110.5/80, i.e., the upper bound of the saturation factor=minimum (−56.4/−30, 110.5/80)=minimum (1.88, 1.38)=1.38

Step 110: multiple chrominance vector (Cb, Cr) of the image pixel by the saturation factor generated in step 108; and

Step 112: end.

In the example in step 108, if the upper bound of the saturation factor is set to a smaller value of −56.4/−30 and 110.5/80, then step 110 will adjust chrominance vector of the image pixel to

$$( - {30}^{*} \frac{110.5}{80} , {80}^{*} \frac{110.5}{80} ) = ( - 41.4 , 110.5 )$$

so that the image pixel consists of a vivid color and the contour artifacts will not appear on the image. If the saturation factor is set to a value smaller than 110.5/80, after adjusting, although the contour artifacts do not appear on the image, the image will not show the most vivid color. If the saturation factor is set to a value greater than 110.5/80, after adjusting, although the image appears to be vivid, due to maximum chrominance vector corresponding to luminance exceeding 100, contour artifacts will appear, therefore the most ideal saturation factor is 110.5/80.

In the method 100, although video image V is represented as color model W, Cb, Cr) under CIE standard, however, the method of adjusting saturation of an image of the present invention is also capable of adjusting saturation of a video image of any color model presented. For example, the video image can be (U, V, W) of CIE standard, (Y, I, Q) of NTSC standard, (Y, U, V) of PAL standard, or (W, Pb, Pr) of digitized component. These color models have predetermined conversion formulae, in other words, the formulae existing in between any color model and corresponding color model can be applied. For example, in the formulae existing in between (R, G, B) and (Y, I, Q) of NTSC standard is

$$[ \begin{matrix}0.299 & 0.587 & 0.114 \\ 0.596 & - 0.275 & - 0.321 \\ 0.212 & - 0.523 & 0.311\end{matrix} ] , therefore ( Y , I , Q ) = [ \begin{matrix}0.299 & 0.587 & 0.114 \\ 0.596 & - 0.275 & - 0.321 \\ 0.212 & - 0.523 & 0.311\end{matrix} ] ( R , G , B ) .$$

In comparison to the prior art, the method of adjusting saturation of an image of the present invention changes accordingly to luminance of the image pixel. Also by generating a saturation factor according to maximum chrominance vectors corresponding to luminance of the image pixel in each sub-color palette, and multiplying maximum chrominance vectors of the image pixel by the saturation factors. In this way, the image pixel, after adjusting, will consist of the best vivid colors and without showing any contour artifacts.

Those skilled in the art will readily observe that numerous modifications and alterations of the device and method may be made while retaining the teachings of the present invention. Accordingly, the above disclosure should be construed as limited only by the metes and bounds of the appended claims.

1. A method of adjusting saturation of luminance-based video, the method comprising:
dividing a color space into a plurality of sub colors:
generating a relation between luminance and maximum chrominance vectors in each sub-color; and
adjusting a chrominance vector of an image pixel, wherein the adjusted chrominance vector is equal to the original chrominance vector multiplied by a saturation factor corresponding to the image pixel.

2. The method of claim 1, wherein the relation between luminance and maximum chrominance vectors in each sub-color is generated according to a position where each sub-color is located in a color space.

3. (canceled)

4. The method of claim 1, further comprising:
generating the saturation factor corresponding to the image pixel according to a maximum chrominance vector corresponding to the luminance of the image pixel.

5. (canceled)
